(19) United States
(12) Patent Application Publication
(10) Pub. No.: US 2015/0314553 A1
(43) Pub. Date: Nov. 5, 2015

(54) REINFORCED STRUCTURAL COMPONENT MADE OF COMPOSITE MATERIAL

(71) Applicant: AIRCELLE, Gonfreville L'Orcher (FR)

(72) Inventors: Bertrand DESJOYEAUX, Sainte Adresse (FR); Patrick DUNLEAVY, Palaiseau (FR)

(73) Assignee: AIRCELLE, Gonfreville L'Orcher (FR)

(21) Appl. No.: 14/796,490

(22) Filed: Jul. 10, 2015

Related U.S. Application Data
(63) Continuation of application No. PCT/FR2014/050033, filed on Jan. 9, 2014.

(30) Foreign Application Priority Data
Jan. 11, 2013 (FR) 13/50284

(51) Int. Cl. B32B 3/26; B32B 37/18

(52) U.S. Cl. CPC B32B 3/266; B32B 37/18; B32B 2305/08; B32B 2305/188

(57) ABSTRACT

A structural component is made of composite material, including at least one assembly orifice, the component being composed of a stack of plies of fibers which include at least one layer of plies of regular fibers and at least one reinforcing ply. The reinforcing ply is composed of a woven composite textile preform formed by a weave obtained by assembling a plurality of circumferential warp fibers that form a path around the assembly orifice and weft fibers that extend radially with respect to the center of the orifice.

### CROSS-REFERENCE TO RELATED APPLICATIONS

This application is a continuation of International Application No. PCT/FR2014/050033, filed on Jan. 9, 2014, which claims the benefit of FR 13/50284, filed on Jan. 11, 2013. The disclosures of the above applications are incorporated herein by reference.

### FIELD

The present disclosure relates to the field of manufacturing structural parts made of a composite material and a method for manufacturing such a structural part.

### BACKGROUND

The statements in this section merely provide background information related to the present disclosure and may not constitute prior art.

It is possible to manufacture parts made of composite materials from laminates constituted by a stack of folds, each fold including long fibers extending substantially parallel to each other or cross-woven together.

The main interest of this type of material lies in the possibility of improving their mechanical properties to the loads.

Indeed, the specific orientation of the fibers may be defined with respect to the direction of the local loads in the parts.

Thus, the mechanical properties of the laminate are directly related to the sequence of the different folds of extended fibers and the orientations of the fibers in the stack. Thus, for these extended folds, there are used either webs of unidirectional fibers, or bidirectional fabrics, or materials called multiaxial materials, or interlocks or 3D multilayered fabrics.

Therefore, the material may be defined so as to withstand the loads to which it is intended.

These structures made of a composite material are obtained by techniques consisting in draping dry or pre-impregnated fibers which are consolidated by impregnation and polymerization of resin.

In these structural parts, orifices may be formed, in particular for inserting an axis which enables the assembling of several parts in order to transmit forces.

In particular, we can mention the example of clevises of connecting rods made of a composite material which include orifices intended to receive an axis.

However, the presence of orifices causes concentrations of stresses due to the insertion of the axis in the orifices which require to locally reinforce the structural parts around their orifices.

One solution consists in realizing a reinforcement by increasing the thickness of the structure around the hole, by realizing a stack of folds disposed alternately in various directions. For example, layers of fibers are alternated in 4 directions angled at 45° relative to each other, or layers of bidirectional fabrics having directions at 0° and 90° on the one hand and at +/−45° on the other hand, are successively stacked. In such a case, it is possible to obtain a part whose laminate includes as much fibers in each one of the 4 directions, as soon as a sufficient number of layers of folds is considered. The ratio of each one of the 4 directions is of 25% or an approximate ratio. Thus, a laminate called ‘quasi-isotropic’ laminate is obtained, that is to say a laminate having substantially identical properties in all radial directions around the hole, which gives an equivalent caulking ability in each radial direction around the hole.

This solution results in an increase of the thickness around the orifice and thus increases the weight of the structure. This solution also requires a large-sized ligament for holding a clevis.

Another solution then consists in reinforcing the contour of the ligament with mainly unidirectional fibers strapped around the area of the hole so as to constitute the peripheral ligament. This solution provides good tensile strength thanks to these peripheral fibers, but it provides no improvement in case of compression on the edge of the hole at the opposite side of the ligament. In addition, the interface connection between the stacks of layers of fibers at the edge of the hole and the strapping fibers, introduces a discontinuity of structure which may turn out to be insufficient.

Another solution then consists in embroidering around the hole, a carbon roving, with a zig-zag stitch.

Nonetheless, this solution is not sufficient, in particular in terms of mass: it has been observed that some used yarns around the hole are actually useless, when regarding the forces to be transmitted, and are unduly detrimental to the weight of the concerned part.

Moreover, the production of this technique is slow in comparison with weaving techniques.

### SUMMARY

The present disclosure provides a structural part made of a composite material presenting an innovative orifice.

The present disclosure also provides a structural part made of a composite material wherein the mechanical strength of the nearby area of the orifice is enhanced while reducing mass and providing a desired thickness at this area.

The present disclosure also improves the caulking strength in the structural parts presenting an assembly orifice reducing the risks of delamination at the edge of the orifice.

The present disclosure also provides a structural part presenting an assembly orifice whose ligament strength is improved.

To this end, the present disclosure provides a structural part made of a composite material comprising at least one assembly orifice, said part being composed of a stack of common fiber folds comprising at least one layer of oriented unidirectional fiber folds or at least one layer of oriented fabric or braid extending beyond the peripheral area of the orifice, and at least one reinforcing fold around the orifice.

This part is remarkable in that the reinforcing fold is composed of a woven composite textile preform formed by a weave obtained by assembling several circumferential warp fibers forming a path around said assembly orifice and weft fibers extending radially with respect to the center of said orifice.

Thanks to the present disclosure, the presence of a local reinforcement at the orifices of a structural part formed by a woven preform improves the caulking strength around the hole, and improves the ligament strength of the concerned part while limiting the mass of this reinforced part.

Therefore, the present disclosure responds to the service loads in particular when transmitting the forces of the parts made of a composite material at their orifices.

According to another form of the present disclosure, considered individually or in combination:

the textile preform of the woven composite reinforcement describes a spiral or annular path, said spiral or said ring being respectively substantially concentric relative to the center of said orifice;

the textile preform of the woven composite reinforcement is formed by a weave obtained by assembling several warp fibers describing the annular or spiral path and weft fibers extending radially relative to the center of said orifice;

the density of warp fibers and/or the titre of the warp fibers of the reinforcing fold is/are substantially uniform between the inner and outer diameters of the woven textile preform;

the density of warp fibers and/or the titre of the warp fibers of the reinforcing fold is/are variable between the inner and outer diameters of the woven textile preform;

the titre of the weft fibers and/or the polar pitch of the weft fibers of the reinforcing fold is/are constant along the circumference of the woven textile preform;

the titre of the weft fibers and/or the polar pitch of the weft fibers of the reinforcing fold may be variable along the circumference of the woven textile preform;

the density of warp fibers of the woven textile preform is constant or progresses along different angular orientations around the orifice;

at least one reinforcing fold is arranged on the thickness of the structural part between two layers of common fiber folds constituting the common structure of the part;

one or several reinforcing fold(s) is/are arranged on the thickness of the structural part on one or several layer(s) of common fiber folds, forming the outer and/or inner faces of the stack;

the reinforcing folds arranged on the thickness of the structural part are identical or different;

The extent of the reinforcing folds is different from one layer to another providing a gradual progression of the thickness of the part around the hole;

at least one woven textile preform forming a reinforcing fold comprises an orifice intended to be placed in line with the assembly orifice of the part;

the drape of the entire part including the area of the orifice is constituted by at least one fold of common fibers constituted by at least either one of the types such as layers of unidirectional fibers, layers of bidirectional fabrics, layers of mutliaxial assembled fibers, interlock woven structures locally loosened or not around the hole and at least one reinforcing fold;

at least one portion of the stack of the reinforcing folds and fibers layers of the part, is reinforced by Z-like reinforcements;

the fibers which constitute the reinforcing folds and the fibers layers of the part and the Z-like reinforcements are selected among carbon fibers, glass fibers, Kevlar fibers, of one single type or in combinations;

the part forms at least one clevis including an orifice intended for assembly by insertion of an axis or a fixing.

The present disclosure further concerns a method for realizing a structural part made of a composite material and comprising at least one assembly orifice as mentioned above.

This method comprises a step of draping a stack of fiber folds and a step of consolidating the stack aiming to secure the fibers of the different folds together by polymerization of a resin so as to obtain said part.

During the step of draping the stack of folds, at least one layer of common fiber folds, that is to say extending to the part beyond the immediate peripheral area of the orifice, is deposited and at least one reinforcing fold composed of a woven textile preform formed by a weave obtained by assembling several circumferential warp fibers describing a path around said assembly orifice and weft fibers extending radially with respect to the center of said orifice.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic perspective representation of a stack of layers of common fibers and layers of reinforcements forming a reinforced structural part made of a composite material according to a first form of the present disclosure;

FIGS. 2a illustrates one step of a method for manufacturing a reinforced part of FIG. 1;

FIG. 2b illustrates a successive step of the method step of FIG. 2a for manufacturing the reinforced part of FIG. 1;

FIG. 3 is a front view of the part obtained in FIG. 2b wherein the orientation of the fibers is visible;

FIG. 4a is a view representing a partial weaving of a reinforcing fold;

FIG. 4b is a front view of a woven reinforcing fold according to a first form;

FIG. 5a illustrates one form of the weaving of a reinforcing fold;

FIG. 5b illustrates another form of the weaving of a reinforcing fold;

FIG. 6a illustrates one variant of the weaving of the reinforcing fold;

FIG. 6b illustrates another variant of the weaving of the reinforcing fold;

FIG. 7 illustrates another variant of the weaving of the reinforcing fold;

FIG. 8a is a sectional view across the thickness showing different one arrangement of the reinforcing folds in a stack of common folds of a part according to the present disclosure;

FIG. 8b is a sectional view across the thickness showing different another arrangement of the reinforcing folds in a stack of common folds of a part according to the present disclosure;

FIG. 8c is a sectional view across the thickness showing different another arrangement of the reinforcing folds in a stack of common folds of a part according to the present disclosure;

FIG. 8d is a sectional view across the thickness showing different another arrangement of the reinforcing folds in a stack of common folds of a part according to the present disclosure;

FIG. 9a is a perspective view of portions of parts including an orifice which may be reinforced according to one form of the present disclosure;

FIG. 9b is a perspective view of portions of parts including an orifice which may be reinforced according to another form of the present disclosure;

FIG. 9c is a perspective view of portions of parts including an orifice which may be reinforced according to another form of the present disclosure; and

FIG. 9d is a perspective view of portions of parts including an orifice which may be reinforced according to other form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

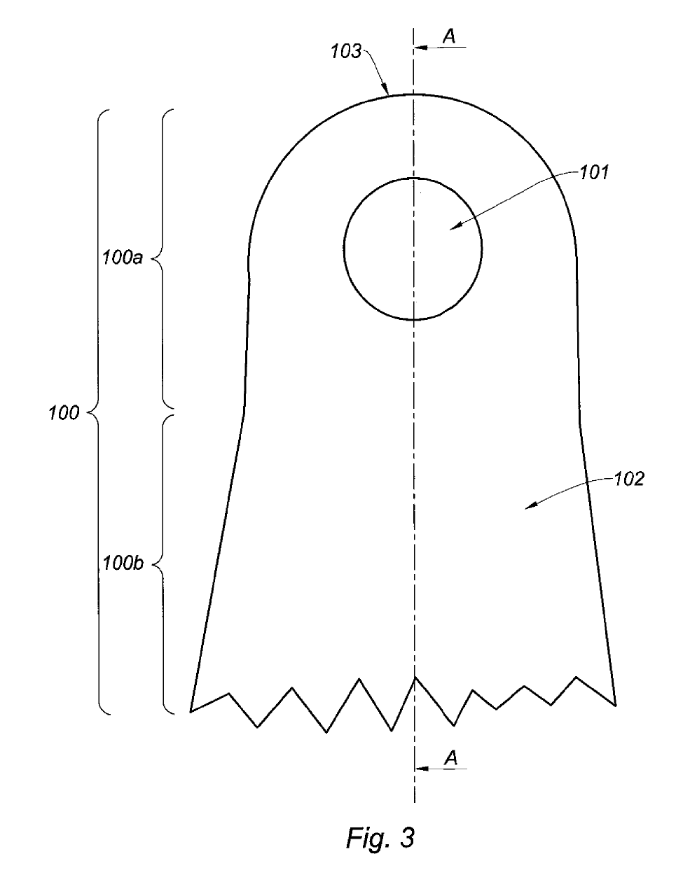

Referring to FIG. 3, there is shown a structural part made of a composite material according to the present disclosure in the form of a part 100 including a common area 100a and a clevis area 100b surrounding an orifice 101.

In particular, this orifice 101 allows assembling the part 100 with adjacent elements, such as for example setting up a pivot axis in the orifice 101.

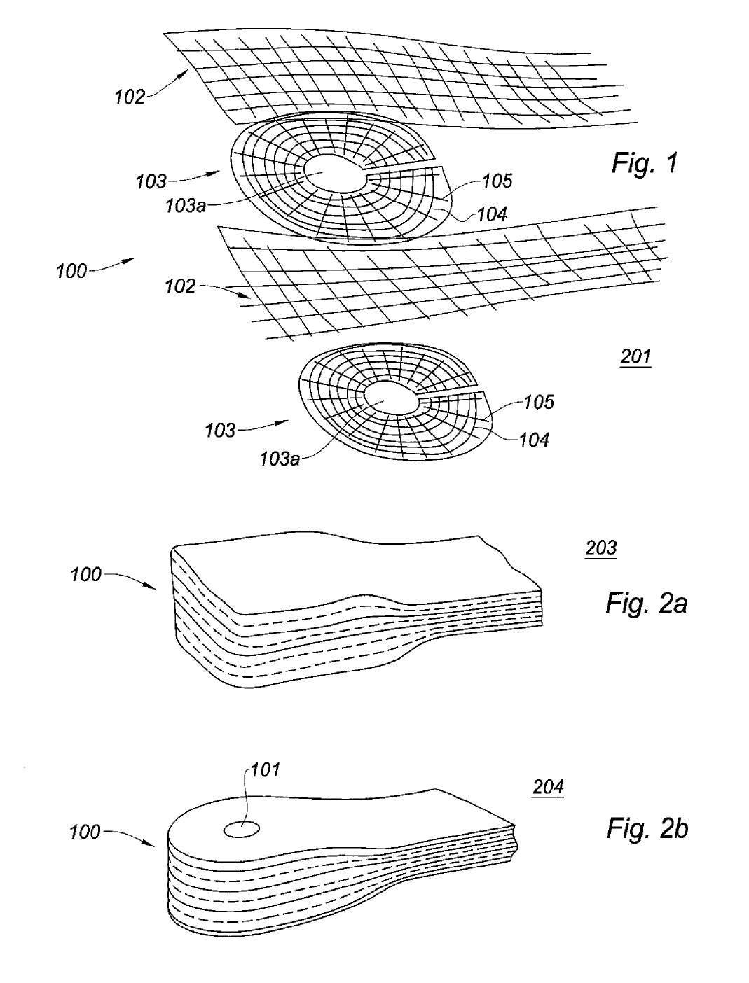

This structural part made of composite material 100 according to the present disclosure is composed of a stack of fibers comprising at least one layer 102 of common fiber folds extending beyond the circumference area of the orifice so as to drape a larger portion of the part or the entire part and at least one reinforcing fold 103, as is illustrated more particularly in FIG. 1.

In FIG. 1, there is represented a perspective view of a stacking sequence of layers of fibers according to one form of the present disclosure. As a non-limiting example, the stack of folds is composed of layers of common fiber folds 102, and of local reinforcing folds 103, arranged alternately through the thickness of the structural part so as to redistribute the forces between the peripheral area of the orifice and the common area of the part.

By layer 102 of common fiber folds, it is meant a set of fibers bonded together according to a planar or surface organization, and complying with an assembly architecture known under different names such as unidirectional web, 2D fabric, multiaxial fabric, multilayered fabric, braids or any other weaving mode.

A unidirectional web is an assembly of fibers all parallel to each other.

A 2D fabric is a woven assembly of fibers in at least two directions. In general, it is question of warps and wefts 2D fabric, which warps and wefts are interwoven according to different patterns such as plain, taffeta, twill and satin.

A mutliaxial fabric is an assembly of multiple webs of unidirectional fibers successively stacked along different directions, the webs are bonded together by periodic stitches through the thickness. Thus, there are multiaxial, bidirectional fabrics still called bibiais when the two consecutive layers are disposed at positive and negative angles on either side of the longitudinal axis of the material. There are also triaxial or quadriaxial fabrics.

A multilayered fabric or interlock fabric, is a fabric including at least 2 layers of warps or 2 layers of wefts, which are interwoven so that the whole set of woven fibers constitutes a bonded material.

A braid is a material obtained by braiding fibers together.

According to the present disclosure, each reinforcing fold 103 is composed of a woven composite textile preform 103.

This woven composite textile preform 103 is formed by a weave obtained by assembling several circumferential warp fibers 104 describing a path around said assembly orifice 101 and weft fibers 105 extending radially with respect to the center or to the central axis passing through the center of the assembly orifice 101.

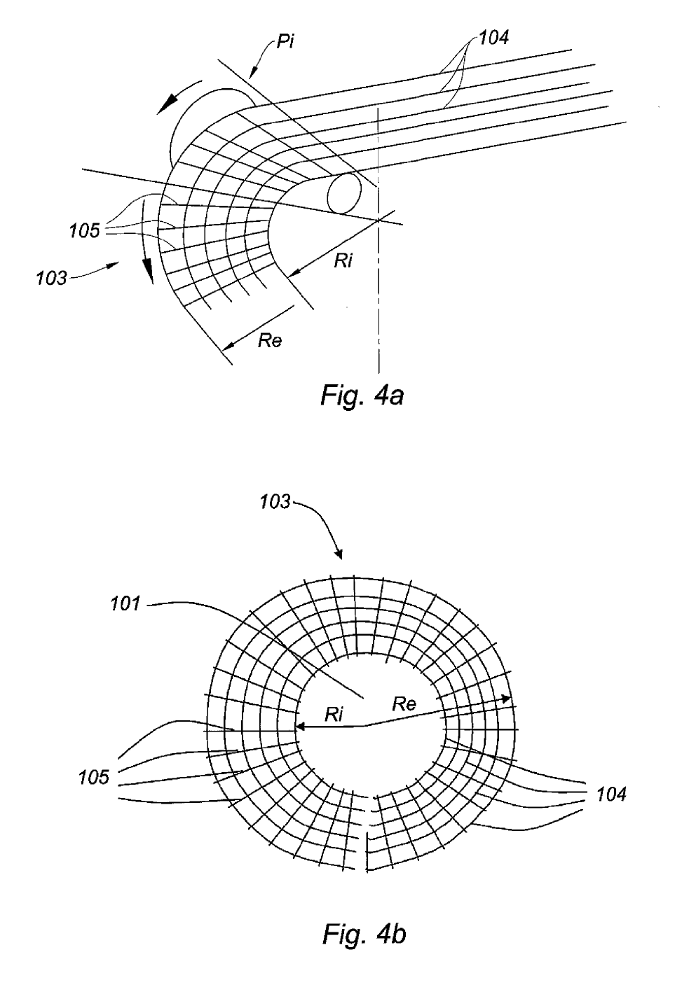

In a first form, this woven composite preform 103 is an annular ring, as is illustrated in FIGS. 4a and 4b.

In this first case, the woven preform 103 is formed by a weave obtained by assembling circular warp yarns 104 and radial weft yarns 105 extending radially with respect to the center or to the central axis of the preform 103. When realizing the preform, the weft yarns 105 are interwoven with the warp yarns 104, on a weaving loom, with any desired weaving pattern. The device for taking up the warp yarns, such as for example represented in FIG. 4a by a conical roll, provides the disc-like arrangement of the weaving downstream of the insertion point Pi of the wefts between the radii Ri and Re.

Thanks to the presence of reinforcing folds 103 in the form of a woven composite textile preform, there are provided, on the one hand, a good resistance to caulking of the stack of folds in the edge area of the assembly orifice 101 of the part, and on the other hand, a good resistance to the tensile-compressive-bending loads exerted when assembling the part with an element of the fixing-type, axis-type or others.

The weaving structures which provide reinforcing fibers radially to the axis of the assembly orifice 101 improve the caulking strength of the concerned part, allowing to limit the section and the height of the axis for a same transmitted force, and hence allowing to reduce the thickness and the mass of the thus reinforced part.

The weaving structures which provide fibers disposed circumferentially to the orifice, allowing to improve the ligament strength of the stack around the assembly orifice 101.

Furthermore, the stacking between reinforcing folds 103 with folds of common area 102, the dimensions and shapes of the different reinforcing folds 103, allow transferring harmoniously the forces from the hole area to the whole part, without creating an area where the structure changes abruptly, thereby conferring a desired behavior to the part.

Thus, the mechanical strength of the whole stack is improved, in particular on the circumference of the assembly orifice 101 of the structural part 100.

This advantage of the reinforcing folds 103 in the proximity of the orifice 101, allows to reduce the total thickness of the required fibrous reinforcement at the edge of the hole so as to withstand the forces, and also allows to limit the dimension of the ligament around the orifice 101, and hence allows to significantly reduce the mass of the part, as well as the thickness of the hole area, thereby allowing to reduce the length of the assembly axis. Thus, it is possible for an aeronautical equipment to reduce from 10 to 30% of the necessary functional mass in the case of an orifice with an assembly axis.

This objective is further advantageously enhanced by implementing, on the one hand, different distributions of the warp fibers and weft fibers in the preform 103 according to the present disclosure, and on the other hand, different stacks between the common folds 102 and the reinforcing folds 103, as will be explained below.

Several variants of constructions may be used independently or in combination.

FIG. 4b presents a first form of a reinforcing fold 103. It may be seen that the ratio between circumferential warps and radial wefts of a reinforcing fold 103 may progress, for a given pattern depending on the radius. Either a uniform arrangement of the warp fibers 104, such as N fibers per centimeter width of the woven preform 103. Or, on the other hand, rolls and the warps disposed so that, with rotation of the conical roll for taking up the weaving, the circumferential warp fibers 104 fit into a disc between a radius Ri and Re. The advance of the warp take-up may be fixed, so that along the radius Ri, there are also N weft fibers per curvilinear centimeter. Since these same fibers extend radially, there are observed along the radius Re, a number Ne of weft fibers per cm inversely proportional to the ratio of the radii: Ne=N×(Ri/Re).

In a first set of variants of the preform 103, variations related to the warp fibers are advantageously introduced, allowing to vary the proportion of circumferential fibers 104 in the proximity of the outer radius Re of the preform relative to the radius Ri of the woven reinforcement 103.

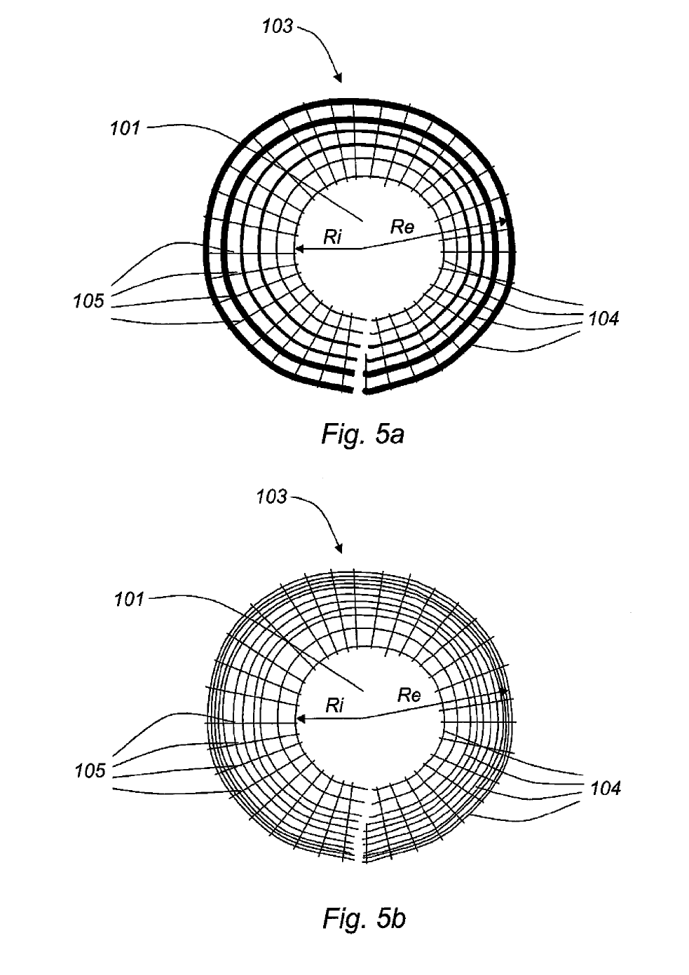

In a first variant, an example of which is represented in FIG. 5a, the titre of the warp yarns is variable between different radii of the woven reinforcing preform 103, the titre of one fiber is the linear mass of the used roving of yarns. Thus, for example, warp fibers 104 with lower titre are installed immediately proximate to the radius Ri, and fibers with higher titre are installed toward the radius Re.

For example, for an aeronautical structure, carbon fibers are generally used. The titres of carbon fibers are generally chosen among rovings of 1K, 3K, 6K, 12K, and even 24K, and even more. For high-resistant fibers, the titres of these different rovings are respectively substantially equal to 67 tex, 200 tex, 400 tex, 800 tex, and even 1600 tex (tex is a titre unit: 1 tex=1 g per kilometer of roving). For example, it is possible to use fibers of 3K or 200 tex for the warps positions close to Ri, and progressively increase the titre up to 12K or 800 tex for the warps positions close to Re. This arrangement is given as a non-limiting example.

In a still another variant an example of which is represented in FIG. 5b, the warp fibers density N is varied along the radius between Ri and Re. Thus, preferably, it is possible to have a low warp fibers density N, in the proximity of the radius Ri, and progressively increase it in the vicinity of the radius Re.

For example, for the types of fibers which have been indicated previously, it is possible to vary the warp fibers density, from 2 yarns per centimeter, to almost 5 yarns per centimeter.

Thus, for an insertion rate of wefts 105, which is constant along the perimeter of the preform, these variants result in varying the ratio between surface mass of warp or circumferential fibers and surface mass of weft or radial fibers of the reinforcing fold 103 between the radii Ri and Re. It is common to weave according to a warp/weft ratio of 30%/70%, namely about 0.4, which may be applied in the proximity of the radius Ri in contact with the orifice 101 to about 70%/30%, namely about 2.3, at the outer contour of the ligament around the orifice. Hence, the proportion of radial fibers at the edge of the orifice 101 is increased, increasing thereby its caulking strength, and the proportion of circumferential fibers is increased at the periphery of the ligament around the orifice, increasing the strength of the opening or tearing of said ligament.

In other variants of the preform 103, variations related to the weft fibers are advantageously introduced, allowing to have more or less density of wefts at the border of the orifice 101 depending on the angular orientation.

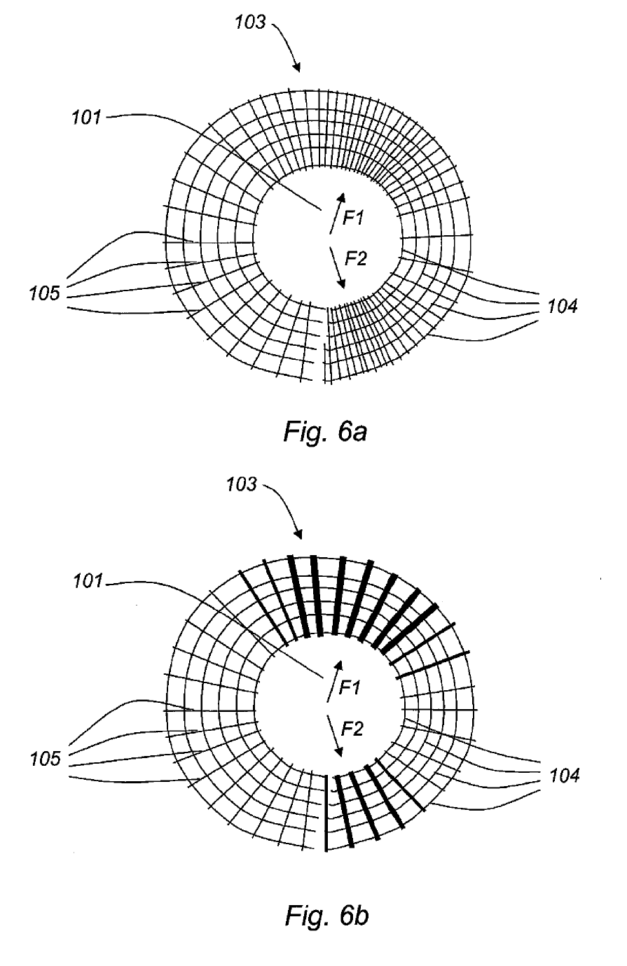

In a variant of the preform 103 an example of which is represented in FIG. 6a, the pitch of the weft fibers 105 progresses with the angular positions around the axis of the orifice 101. Thus, for example, the weft fibers density is chosen to be maximum in the angular sectors of the part where it is desired to maximize the caulking strength at the hole side, and the weft fibers density is decreased in the directions where it is less useful. Thus, in the example shown in FIG. 6a, it is assumed that the orifice may be subjected to caulking forces along the two directions F1 and F2, directions facing which the weft fibers density is maximized. Similarly, since the part will undergo less caulking loads in the other directions, the density of wefts is significantly reduced, outside of the sectors corresponding to F1 and F2.

In another variant of the preform 103, as is disclosed in FIG. 6b, the weft mass ratio is increased along the directions F1 and F2, by increasing the titre of the weft yarn inserted radially facing these directions. A lower titre of the weft fibers reducing the proportion of radial fibers relative to the circumferential fibers in the rest of the thus woven reinforcing fold.

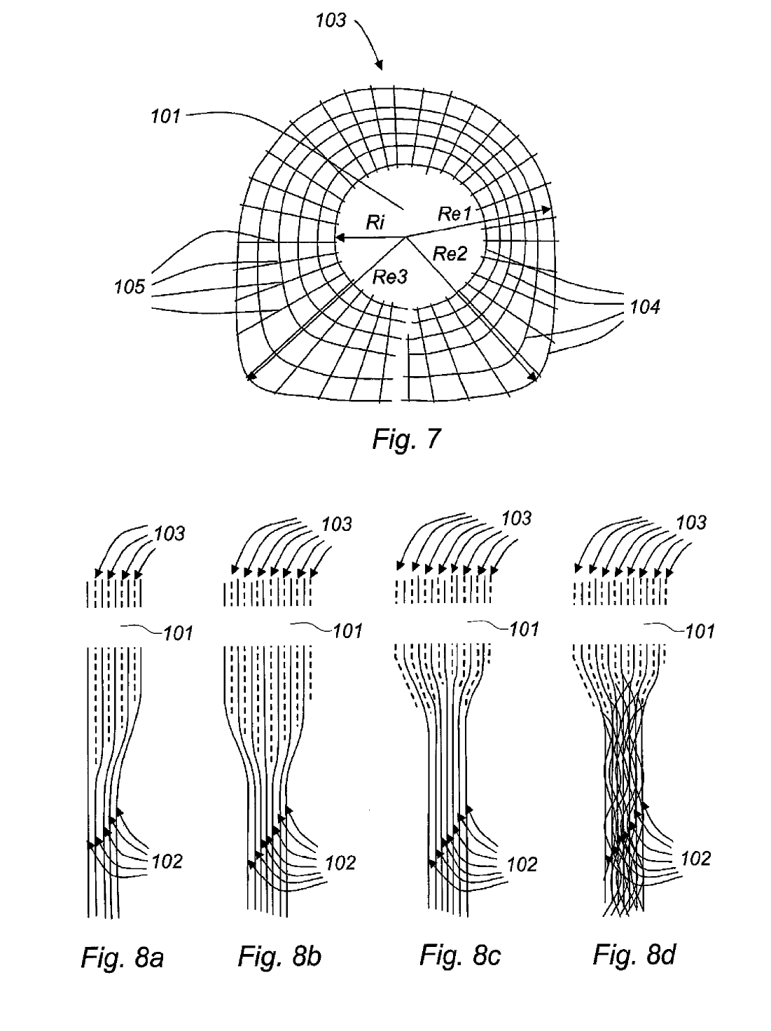

In a still another variant, as is shown in FIG. 7, the spacing pitch of the warp fibers 104 progresses depending on the angular position along the circumference of the reinforcing fold 103 and the circumference around the orifice 101. Thus, in a particularly preferred manner, for a reinforcing fold with a radius Ri, the outer radius progresses along the circumference between at least two values Re1 and Re2, and even Re1 and Re3. This property of the preform 103 may be achieved by a device provided on the weaving loom with a variable reed having the effect of spacing apart more or less the circumferential warp fibers from one another, after successive adjustments at different positions of insertions of the wefts. Such devices allow modifying the width of a weaving in a proportion which may range from 1 to 3.

This particular arrangement of the reinforcing fold 103 extends the arrangement of the circumferential warp fibers. Thus, the reinforcing fold 103 is no longer a disc with a constant width, but with a variable width.

This particular feature of the reinforcing fold 103 allows for example to extend the circumferential fibers substantially parallel to the direction of the forces which are exerted on the orifice 101 and to distribute them over a larger surface area to the common folds 102 of the part.

For all these variants of preforms of reinforcing folds 103, the weave of the weaving may be uniform over the whole fold, or variable, depending on the arrangements of the titres of the different circumferential warp fibers and radial weft fibers, in order to preserve a good strength of the preform. The different known patterns, such as plain, twill, satin, may be used.

Similarly, various types of fibers may be used exclusively or in combination.

For example, for warp or circumferential fibers, in particular when the radius Ri is small that is to say in the order of 15 to 30 mm, it may be preferable to use twisted fibers, in order that all filaments contribute to the circumferential forces as uniformly as possible.

Fibers that are commonly employed for the structural composite materials may be used, such as glass fibers, carbon fibers, aramid fibers, etc. . . .

All of these variants of preforms of reinforcing folds 103 are used individually or in combination for each reinforcing fold 103 forming the drape of the part 100 with an orifice 101.

Moreover, in other variants which do not exclude the previous ones, each reinforcing fold 103 may extend over a more or less significant angular sector around the orifice 101 or according to a spiral or helical shape.

When the woven preform 103 extends angularly of less than 360° [deg.], the ligament strength is improved with respect to the caulking strength of the part 100.

In a variant of configuration of the reinforcing fold 103, the latter describes a complete turn, namely 360°.

In one variant, the radial fibers 105 are woven up to the end of the circumferential fibers, maintenance of the weaving at the border of the weaving is achieved by different accessory elements, such as particles or filaments of meltable materials which achieve local adhesion of the radial and circumferential fibers.

In another variant, the circumferential fibers 104 of at least either one of the ends of the reinforcing fold 103, describe slightly more than 360° covering then the opposite end of the reinforcing fold, providing a circumferential continuity of mechanical strength of the reinforcing fold.

In a still another variant, the reinforcing fold 103, extends only over a partial angular sector at least larger than the 180° of the ligament. In particular, if the part is mainly subjected to tensile loads via the orifice 101, the improvement of the structure mainly concerns the outer ligament.

The reinforcing fold 103, according to a combination of the previous variants, is used within the stack of layers of fibers of the part 100.

In a first stacking configuration, a common fibers fold 102 and a reinforcing fold 103 are alternately disposed.

Depending on the total required thickness, the first and last folds of the stack, when taken individually, may be either a common fold 10 or a reinforcing fold 103.

In one variant, several reinforcing folds 103 are inserted at different thicknesses between different common folds 102, and at least one of these folds 103 is different from another.

In a variant in particular, the outer contours of the different folds 103 are more or less extended. Thus, the increase of thickness of the part 100 in the vicinity of the orifice 101 is progressive, which allows the common folds 102 to better withstand the forces. Depending on the difficulty of draping and of compacting, the constitutive materials of the common folds 102, the architectures of the reinforcing folds 103, it is possible to organize the decrease of the extensions of the folds 103 monotonically, from the middle of the thickness toward the surfaces, or from one surface toward the other, or still alternately according to different sequences.

FIGS. 8a to 8d present sectional views of examples of stacking sequences of folds 102 and 103, and different variants of reinforcing folds 103 corresponding to sections along the plane AA defined in FIG. 3:

FIG. 8a concerns an example of a stack of any 2D common folds 102, regularly alternated with reinforcing folds 103; the extension of the folds 103, decreases from one face of the part to the other, facilitating the flat draping of such a part;

FIG. 8b concerns an example of a stack of any 2D common folds 102, alternated with reinforcing folds 103; the extension of the folds 103 progresses from a maximum toward the middle of the thickness to a minimum toward the surfaces;

FIG. 8c concerns an example of a stack of any 2D common folds 102, alternated with alternated reinforcing folds 103; the extension of the folds 103 progresses from a minimum toward the middle of thickness to a maximum toward the surfaces, the extension of the reinforcing folds also decreases at the ligament side;

FIG. 8d shows an example of a stacking sequence according to the mode of FIG. 8c, for which the common folds 102 are realized from an interlock weaving; for this, as is known furthermore, the preform 102 with a warp interlock woven according to any interweaving pattern of warps columns between various layers of wefts, is schematically represented by sinusoidal curves, and in the insertion areas of the reinforcing folds 103, the layers are loosened, that is to say that, progressively, the layers of warp fibers become independent from each other, by interweaving the layers of weft fibers independently with each layer of warp fibers, thereby clearing spaces between the layers allowing the insertion of a reinforcing fold 103;

These arrangements are given as non-limiting examples, other arrangements of the stacking sequence may be considered, as well as the choices of weavings for the common folds 102, and the implementation under different variants of architectures and dimensions of the reinforcing folds 103.

In one form which is not illustrated, each reinforcing fold 103 can in turn be reinforced by additional Z-like reinforcing fibers.

In one variant, at least either one of the reinforcing folds 103 and at least one reinforcing fold 102, are partially bonded by a reinforcement along the Z-like direction or substantially perpendicularly to the draping plane of the folds 102 and 103. Preferably, most of the folds 102, and 103 are bonded by a reinforcement along the Z-like direction. This reinforcement may be realized, either by a technique called Z-pining, or tufting, or needling technique which consists in stitching fibers of the same type or of different types between the layers of fibers, thereby enhancing the resistance to delamination of the layers together and delaying the propagation of the delamination between the layers which leads to the total loss of the part.

All the previous variants of the reinforcing folds 103, also apply to stacks of common folds 102, realized using fabrics or 2D webs or multilayered preforms. For the multilayered preforms such as interlock or 2D materials, the layers of warp yarns should be loosened locally over the entire area where it is desired to insert a reinforcing fold 103.

The different particular reinforcements of the structure around an orifice as described above are generally intended to be brought to another composite structure.

It should be noted that the present disclosure is not limited to the manufacture of assembly clevises but applies on the contrary to any structural part comprising an assembly orifice.

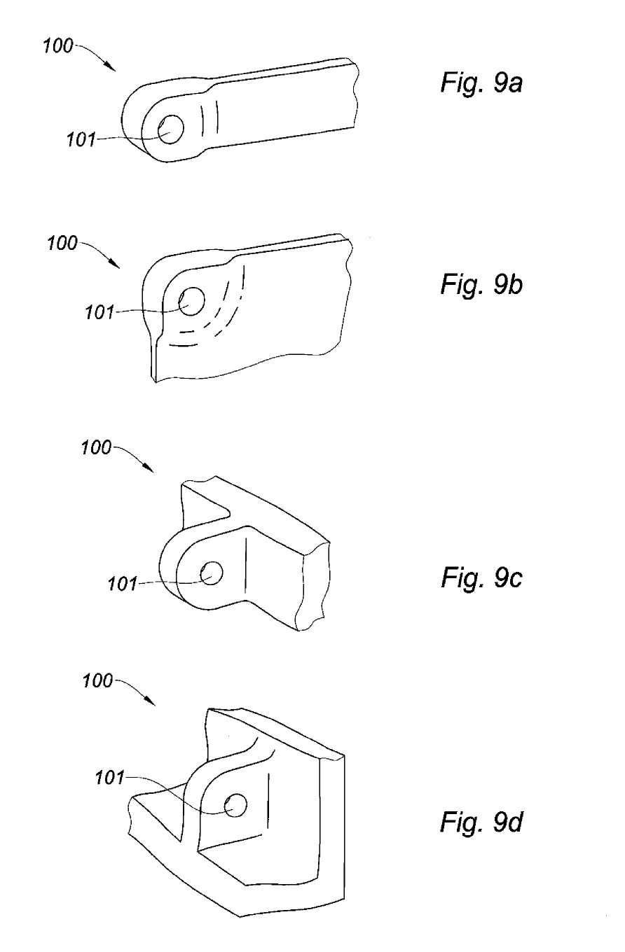

In FIGS. 9a to 9d, there are illustrated several shapes of clevises 100 made of a composite material presenting an assembly orifice 101 which may be formed by structural parts 100 made of a composite material according to the present disclosure.

Thus, mention may be made of a simple straight clevis 100 illustrated in FIG. 9a, a clevis called corner shaped clevis 100 illustrated in FIG. 9b, a clevis called T shaped clevis 100 wherein the assembly orifice 101 is arranged at the stem of the T (illustrated in FIG. 9c) and a clevis called set-square shaped clevis 100 formed by a L-shaped part in the concavity of which there is arranged a transverse wall fitted with the assembly orifice 101 (illustrated in FIG. 9d).

The clevis of FIG. 9a is also represented in FIG. 3 wherein there may be observed a woven composite reinforcing fold 103 on the outer circumference of the assembly orifice 101.

A method for realizing a structural part 100 made of a composite material according to the present disclosure is the following.

It mainly comprises the following steps:

at step 200, illustrated in particular in FIG. 4a, constituting the weaving of the material of the reinforcing folds 103 and cutting them into woven textile preform(s) such as those illustrated in particular in FIGS. 4b, 5a, 5b, 6a, 6b, 7, and according to a combination of variant described above,

at step 201, illustrated in particular in FIG. 1, draping at least one layer of common fibers 102 and at least one reinforcing fold 103 obtained at the previous step, and repeating the operations of draping the layers 102 and 103, to the desired dimensions and arrangements depending on the part, as is illustrated for example in FIGS. 9a to 9d,

at step 202, consolidating the stack obtained at the previous step so as to obtain the structural part 100 by drowning the fibers with the resin according to a process among the family of LCM (liquid composite molding) processes giving a composite structure as is illustrated in FIG. 2a,

at step 203, carrying out the machining of the part, by any process known per se, including in particular, the outer trimming of the part, and if necessary, around the orifice, the drilling and/or the boring the orifice 101, as is illustrated in FIG. 2b, but also possibly the surfacing of the outer faces of the parts, and all other necessary machining operations.

Referring in particular to FIG. 4a or 4b, in the case of a variant of a woven preform describing a spiral path, the weaving of the preform 103 may be realized by taking up the warp fibers 104 of conical take-up rolls.

Since the take-up of the warp fibers is differential between the inside and the outside of the preform 103, the formed preform 103 takes the shape of a spiral. Each reinforcing fold 103 of preform is cut in said spiral so as to realize the angular sector of the desired reinforcement, with the desired terminations.

These warp fibers 104 are woven with the weft fibers 105. According to the type of weaving chosen for the preform 103, the weft fibers 105 may be inserted, for example at the point Pi illustrated in FIG. 4a, by any known means: for instance, by insertion using a rapier, a shuttle or a needle.

The obtained reinforcing fold 103 is formed by spiral warp fibers 104 and radial weft fibers 105.

Referring for example to FIG. 1, in the following draping step, two layers of common folds 102 and two reinforcing folds 103 are alternately placed one after the other in a molding tool.

The reinforcing folds are set in place in the area of the assembly orifice 101 of the structural part 100 to be formed.

Once the stack is set in place, the molding tool is closed and injection is carried out under pressure inside polymerizable resin, which resin will then fill the interstices of the stack.

The molding tool is subjected to a temperature rise which enables the polymerization and the curing of the resin.

This is the stack consolidation step 202.

This process is known by the name of “RTM” (Resin Transfer Molding) process.

Of course, depending on the stacking configurations of the common folds 102 and on the geometric configurations of weaving and stacking of the reinforcing folds 103, the geometry of the part and hence of the tooling, may require variables thicknesses to be established all around the hole. Similarly, different variants of processes may be considered, mention can be made, as a non-limiting example, of VARTM, CRTM, and flexible injection.

In the case of the manufacture of an assembly clevis such as those illustrated in FIGS. 9a to 9d, a trimming step 203 is carried out afterwards by means of a suitable tool so as to form the clevis shape, as well as a drilling and even a boring so as to obtain the assembly orifice 101 of the elaborated structural part 100, as is illustrated in FIG. 2a.

Of course, various modifications may be brought by those skilled in the art to the present disclosure that has just been described, only as non-limiting examples.

What is claimed is:

1. A structural part made of a composite material comprising at least one assembly orifice, said structural part being composed of a stack of fiber folds, comprising at least one layer of unidirectional or woven common fiber folds and at least one reinforcing fold, wherein said at least one reinforcing fold is composed of a woven composite textile preform formed by a weave obtained by assembling several circumferential warp fibers forming a path around said at least one assembly orifice and weft fibers extending radially with respect to the center of said assembly orifice.

2. The structural part according to claim 1, wherein the woven composite textile preform forms a spiral or annular path, said spiral or annular path being respectively and substantially concentric relative to the center of said assembly orifice.

3. The structural part according to claim 1, wherein a titre of the weft fibers and/or a polar pitch of the weft fibers is/are uniform over an angular sector formed by the woven composite textile preform.

4. The structural part according to claim 1, wherein a titre of the weft fibers and/or a polar pitch of the weft fibers is/are variable over an angular sector formed by the woven composite textile preform.

5. The structural part according to claim 1, wherein a density of the warp fibers and/or a titre of the warp fibers is/are uniform between outer and inner diameters of the woven composite textile preform.

6. The structural part according to claim 1, wherein a density of the warp fibers and/or a titre of the warp fibers is/are variable between outer and inner diameters of the woven composite textile preform.

7. The structural part according to claim 1, wherein a width of a reinforcing fold is variable over a whole angular sector formed by the woven composite textile preform.

8. The structural part according to claim 1, wherein at least one reinforcing fold is arranged over a thickness of the structural part between two layers of common fiber folds.

9. The structural part according to claim 8, wherein the reinforcing folds have a variable extent from one layer to another.

10. The structural part according to claim 1, wherein one or several reinforcing fold(s) is/are arranged over a thickness of the structural part on one or several layer(s) of common fiber folds, forming outer and/or inner faces of the stack.

11. The structural part according to claim 1, wherein the reinforcing folds arranged over a thickness of the structural part are substantially identical to each other.

12. The structural part according to claim 1, wherein at least one woven composite textile preform forming a reinforcing fold comprises an orifice arranged in line with the assembly orifice of the structural part.

13. The structural part according to claim 1, wherein at least one reinforcing fold and one common fold are reinforced together by Z-like reinforcements.

14. The structural part according to claim 1, wherein the structural part forms a clevis including an orifice for an assembly.

15. A method for realizing a structural part made of a composite material comprising at least one assembly orifice defined according to claim 1, said method comprising:
a step of draping the stack of fiber folds; and
a step of consolidating the stack configured to secure the fibers of different folds together by polymerization of a resin so as to obtain said structural part,
wherein during the step of draping the stack of fiber folds, there are deposited at least one layer of unidirectional oriented or woven fiber folds and at least one reinforcing fold composed of the woven composite textile preform formed by the weave obtained by assembling the several circumferential warp fibers.
